(19) United States
(12) Patent Application Publication
(10) Pub. No.: US 2002/0087231 A1
(43) Pub. Date: Jul. 4, 2002

(54) Method and apparatus for filling stock orders

(76) Inventors: Jimmy Randolph Lewis, Deer Park, IL (US); Sean Gary McGonagle, Buffalo Grove, IL (US)

Correspondence Address: MARSHALL, GERSTEIN & BORUN, 6300 SEARS TOWER, 233 SOUTH WACKER, CHICAGO, IL, 60606-6357, US

(21) Appl. No.: 09/754,762

(22) Filed: Jan. 4, 2001

(51) Int. Cl. G06F 7/00

(52) U.S. Cl. 700/230

(57) ABSTRACT

Order Filling apparatus and methods are disclosed. A plurality of racks are provided for storing a plurality of products. Each rack has a plurality of bins for holding specific products. A central conveyor is provided for receiving specific products from the bins according to orders. A plurality of intermediate containers are positioned above and along the central conveyor for temporarily holding products from the bins. Each container includes a dispenser operable to discharge products onto the conveyor. An indicator is associated with each bin and includes a light, a number display, and a container display. A computer is operably connected to the container dispensers and bin indicators. The computer assigns containers to parts of the orders and sequentially operates the light, number, and hopper displays of the indicators, thereby directing a stock worker to transfer order parts from the bins to the containers. The computer further operates the dispensers of the assigned containers holding a complete order to discharge at substantially the same point along the conveyor. In addition, a delicate product packing station may be provided for handling breakable stock items.

### FIELD OF THE INVENTION

The present invention generally relates to systems for filling orders for products in less than case lot quantities and, more particularly, to semi-automated systems for picking and filling stock orders.

### BACKGROUND OF THE INVENTION

Order filling or commissioning systems are generally known in the art. Such systems are typically used in environments where a wide variety of products are stored in inventory, and orders are received requesting specific quantities of selected products. It is desirable to fulfill the orders as efficiently as possible so that a greater number of orders may be shipped.

The prior art teaches automatic, manual, and semi-automatic order filling systems. Automatic systems, such as that taught in U.S. Pat. No. 5,271,703, typically use apparatus in which the various products are stored in columns positioned above a central conveyor. Dispensing means are provided for selectively discharging the bottommost unit in each column onto the conveyor. As the conveyor advances toward a discharge end, the desired quantities of each selected item are discharged onto a dedicated section of the conveyor. While this system is relatively fast at dispensing products, it requires a significant amount of labor to stock the columns. Furthermore, it is not well-suited for items having shapes which are not square, since the items must be stacked and dropped from the columns.

On the other end of the spectrum, the pick-to-lights system is a generally known manual approach for filling stock orders. In the pick-to-lights system, a central conveyor is positioned between a pair of racks. Each rack has a number of bins wherein each bin contains a specific type of product. Light and number displays are located near the front of each bin. A computer is provided for receiving order information and operating the light and number displays according to the orders received. A box for holding each order is placed on the conveyor. In operation, a sequence of lights is illuminated according to the order information received by the computer. For example, the computer illuminates the light associated with the bin holding a first product of an order and indicates the desired amount of that product on the number display. The stock worker walks to the illuminated bin, picks up the desired quantity of the product, and places the product in the box on the conveyor. Before depositing the product in the box, the stock worker presses a quitting switch which delivers a pick complete signal to the computer. In response to the pick complete signal, the computer illuminates the light associated with the bin holding the next product on the order list in the same process is repeated. While the conventional pick to lights system is less labor-intensive and is not limited by the shape of the products being dispensed, it is slower than the semi-automatic system described above. Furthermore, the orders must be filled sequentially, and therefore the process will be delayed by slow stock workers or out-of-stock items.

A semi-automatic commissioning system is disclosed in U.S. Pat. No. 5,943,841. This system uses a central conveyor positioned next to a plurality of racks for holding products. A plurality of intermediate containers are positioned above the conveyor belt for temporarily receiving products from the racks. Each container has a hinged bottom, and includes a light and a quitting switch. Stock workers are assigned to sections of the racks for transporting products from the racks to the containers. Each stock worker wears a terminal which displays the selected product and quantity to be picked. A computer is operably connected to the terminals and the containers for directing the stock workers to pick the products. In operation, each stock worker consults the terminal to determine the selected product and quantity for a current picking operation. The computer also illuminates a light associated with the desired container into which the current pick will be deposited. As a result, each stock worker may fulfill portions of several orders by placing the products in the indicated containers as directed by the computer. Once all of the portions of an order are deposited in various of the containers, the computer controls the containers so that they discharge their contents at substantially the same section of the advancing conveyor, thereby grouping together a complete order. In the semi-automatic system, therefore, the orders may be fulfilled and delivered according to completion time rather than taken in sequence as received by the computer. The semi-automatic system is inefficient, however, in requiring the stock workers to consult the terminals during each picking operation.

### SUMMARY OF THE INVENTION

In accordance with certain aspects of the present invention, a method is provided for directing a stock worker to transfer stock items from various storage bins to containers according to a series of orders requesting desired quantities of specific stock items, wherein a light is associated with each bin. The method comprises assigning unique identifiers to each container, illuminating a light associated with a bin holding a current item requested in a first order, and displaying a desired quantity of the current stock item. A container is assigned to the current stock item, and the unique identifier for the assigned container is displayed. The light illuminating, quantity displaying, container assigning, and identifier displaying steps is repeated for subsequent stock items requested in the first and subsequent orders.

In accordance with additional aspects of the present invention, apparatus is provided for directing a stock worker to transfer stock items from various storage bins to containers according to a series of orders requesting desired quantities of specific stock items, wherein each storage bin contains an associated stock item. The apparatus comprises a plurality of lights, each light associated with a bin, at least one number display for showing a desired quantity of each stock item, and at least one container display for showing a unique container identifier associated with a selected container into which each stock item is to be placed, wherein each container is assigned a unique identifier. A computer is operably connected to the lights, the at least one number display, and at least one container display, wherein the computer receives the orders for the stock items and assigns a selected container to each stock item, directs the at least one number display to show the desired quantity of each stock item, directs the at least one container display to show the unique container identifier associated with the selected container assigned to each stock item, and illuminates the light for the bin associated with the specific stock item, so that the stock worker is directed to transfer each stock item from the associated bin to the assigned container.

In accordance with still further aspects of the present invention, apparatus is for assembling orders requesting a series of desired quantities of specific stock items. The apparatus comprises a plurality of bins, wherein each bin holds a specific stock item, a plurality of lights, each light having an associated bin, and a central conveyor positioned near the bins. A plurality of containers is positioned adjacent the central conveyor for temporarily holding stock items from the bins, each container having a unique identifier assigned thereto and including a dispenser operable to discharge stock items onto the central conveyor. At least one number display is provided for showing a desired quantity of each stock item, and at least one container display is provided for showing the unique container identifier associated with a selected container into which each stock item is to be placed. A computer is operably connected to the container dispensers, the at least one number display, the at least one container display, and the lights, wherein the computer receives the orders for the stock items and assigns a selected container to each stock item, directs the at least one number display to show the desired quantity of each stock item, directs the at least one container display to show the unique container identifier associated with the selected container assigned to each stock item, and illuminates the light for the bin associated with the specific stock item, so that the stock worker is directed to transfer each stock item from the associated bin to the assigned container, the computer further controlling the container dispensers holding a complete order to discharge at substantially the same point along the central conveyor.

In accordance with other aspects of the present invention, a delicate product handling apparatus is provided for use with stock order filling apparatus having a central conveyor for receiving stock items, the central conveyor having an upper surface and a discharge end. The delicate product handling apparatus comprises a transfer conveyor having a loading portion positioned adjacent the discharge end of the central conveyor and a discharge portion. A plurality of trays are attached to the transfer conveyor, each tray having an upper surface with a receiving end substantially aligned with the central conveyor upper surface to receive stock items from the central conveyor and a discharge end, wherein each tray is adapted to move to a discharge position at the discharge portion of the transfer conveyor, thereby to discharge the stock items from the discharge end. A packing table is positioned adjacent the discharge portion of the transfer conveyor, the packing table having a top surface with a rear edge substantially aligned with the discharge ends of the trays thereby to receive the stock items discharged from the trays.

In accordance with still further aspects of the present invention, a delicate product handling apparatus is provided for use with stock order filling apparatus having a central conveyor for receiving stock items, the central conveyor having an upper surface and a discharge end. The delicate product handling apparatus comprises a transfer chute having an upper surface with a first end positioned adjacent the central conveyor discharge end to receive stock items from the central conveyor and a second end, wherein the second end is lower than the first end so that the stock items slide from the first end to the second end under gravity force. A chute swing arm is pivotably mounted above the transfer chute and positioned to engage the stock items, the swing arm adapted to actuate between first and second positions thereby to direct the stock items to first and second sides, respectively, of the upper surface second end. A packing table has an upper surface positioned adjacent the second end of the chute upper surface adapted to receive the stock items from the transfer chute.

### BRIEF DESCRIPTION OF THE DRAWINGS

FIG. 1 is a schematic illustration of a portion of a stock order filling apparatus in accordance with the present invention.

FIG. 2 is an enlarged detail of an intermediate container for use with the stock order filling apparatus of FIG. 1.

FIG. 3 is a schematic illustration of a section of the stock order filling apparatus showing primary assignments of rack sections to containers.

FIG. 4 is a schematic illustration of a central indicator positioned in a rack section.

FIG. 5 is a schematic illustration of an alternative integrated bin indicator adapted to be used with each bin of a rack.

FIG. 6 is a schematic plan view of a delicate product packing station for use with the stock order filling apparatus of FIG. 1.

FIG. 7 is a schematic side elevation view of the delicate product packing station of FIG. 6, with a tray in a carrying position.

FIG. 8 is a schematic side elevation view of the delicate product packing station of FIG. 6, with a tray in a discharge position.

FIG. 9 is a schematic plan view of an alternative delicate product packing station for use with the stock order filling apparatus of FIG. 1.

FIG. 10 is a schematic side elevation view of the alternative delicate product packing station of FIG. 9.

### DETAILED DESCRIPTION OF THE PREFERRED EMBODIMENTS

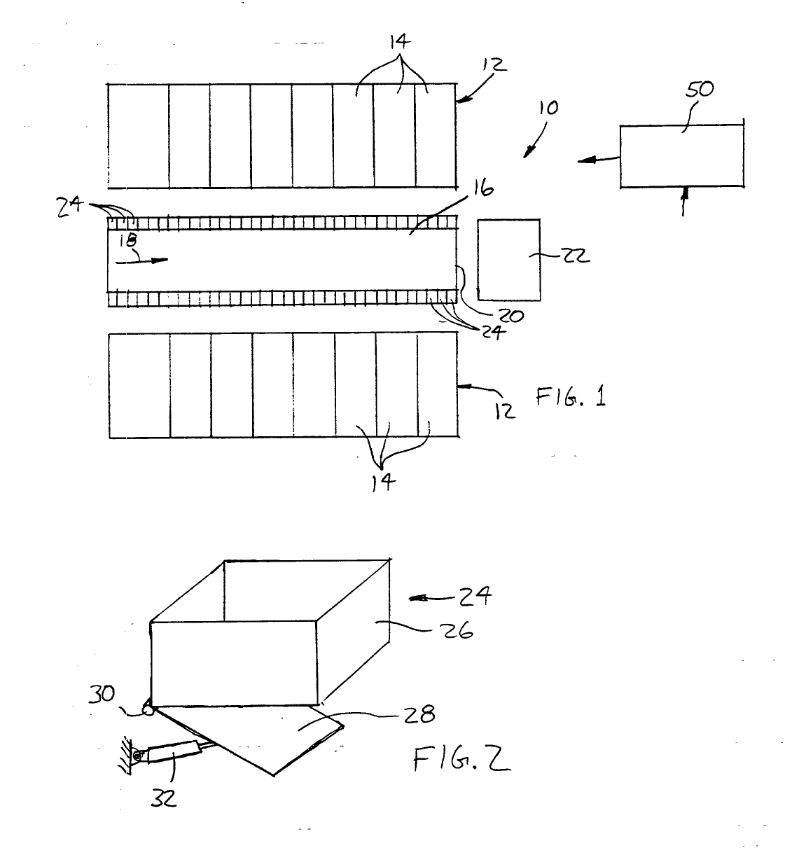

With reference to FIG. 1, an order-filling system in accordance with the present invention is generally designated by the reference numeral 10. The order-filling system 10 is described herein for use in a product distribution center. It will be appreciated, however, that the order-filling system 10 may be used in any type of distribution environment that would benefit from the improved product selection and order distribution efficiencies taught herein.

As shown in FIG. 1, the order-filling system 10 includes a plurality of racks 12 for storing a plurality of stock products. Each rack 12 includes multiple bins 14 for holding the different products. In a preferred embodiment, the racks 12 comprise flow racks in which the bins 14 slant downward toward the front, thereby advancing product toward the front of each bin 14 as a leading unit is removed.

A central conveyor 16 is disposed between the racks 12 for receiving products from the bins 14. The conveyor 16 advances in a direction indicated by arrow 18 toward a discharge end 20 of the conveyor. A tote 22 is positioned at the discharged end 20 of the central conveyor 16 for receiving a group of various products deposited onto a section of the conveyor. As described in greater detail below, the group of products corresponds to a particular order received at the distribution center. The tote 22 is portable so that it may be transported to a packing and shipping area of the distribution center.

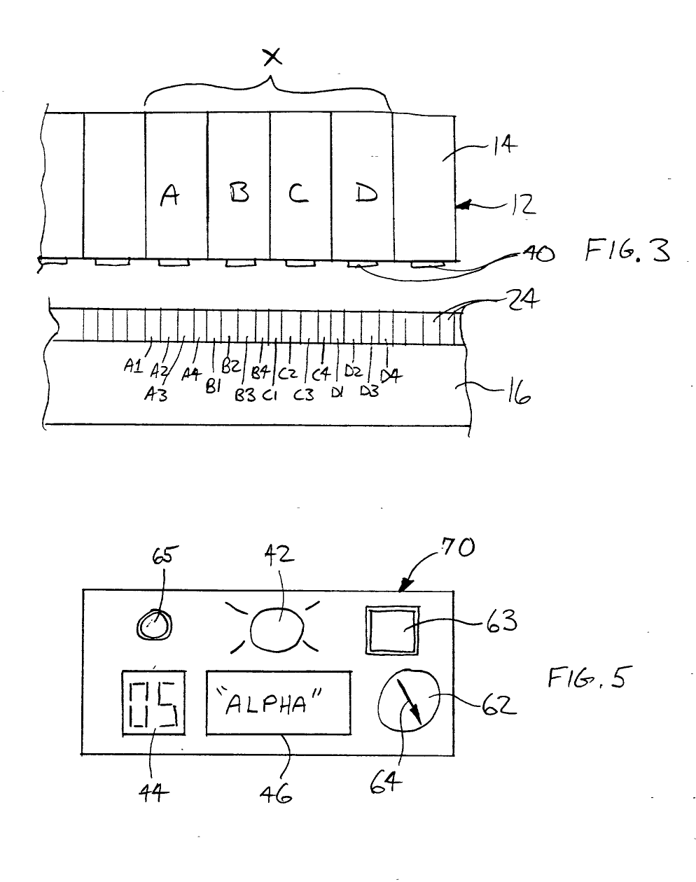

A plurality of intermediate containers 24 are positioned above the central conveyor 16 along the length of the conveyor for receiving products from the racks 12 in the form of partial orders. As best shown in FIG. 2, each container of the illustrated embodiment has a generally rectangular sidewall 26 and a bottom panel 28 attached by a hinge 30 to the sidewall 26. The bottom panel 28 is movable between a closed position, in which the bottom panel 28 engages the bottom of the sidewall 26 to define a receptacle for temporarily holding product from the bins 14, and an open position, in which the bottom panel 28 is rotated away from the bottom of the sidewall 26 so that product held inside the receptacle is discharged onto the conveyor 16. In the illustrated embodiment, an actuator, such as pneumatic piston 32, is attached to the bottom panel 28 to rotate the panel between open and closed positions. It will be appreciated that the movable bottom panel 28 described above is merely a preferred embodiment, and that other discharge mechanisms, such as rotating containers, maybe used to dispense product onto the conveyor 16.

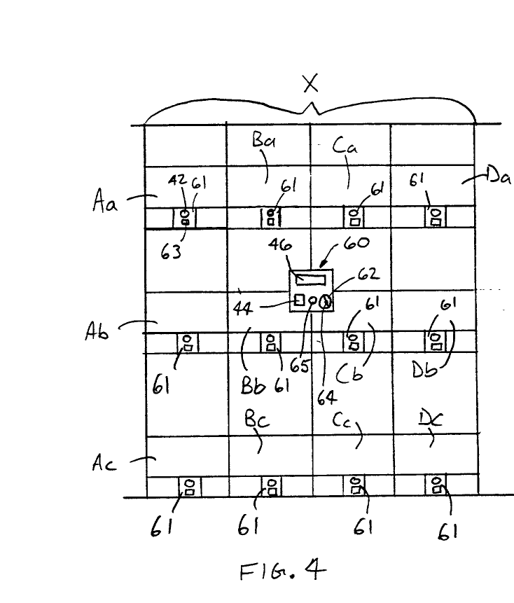

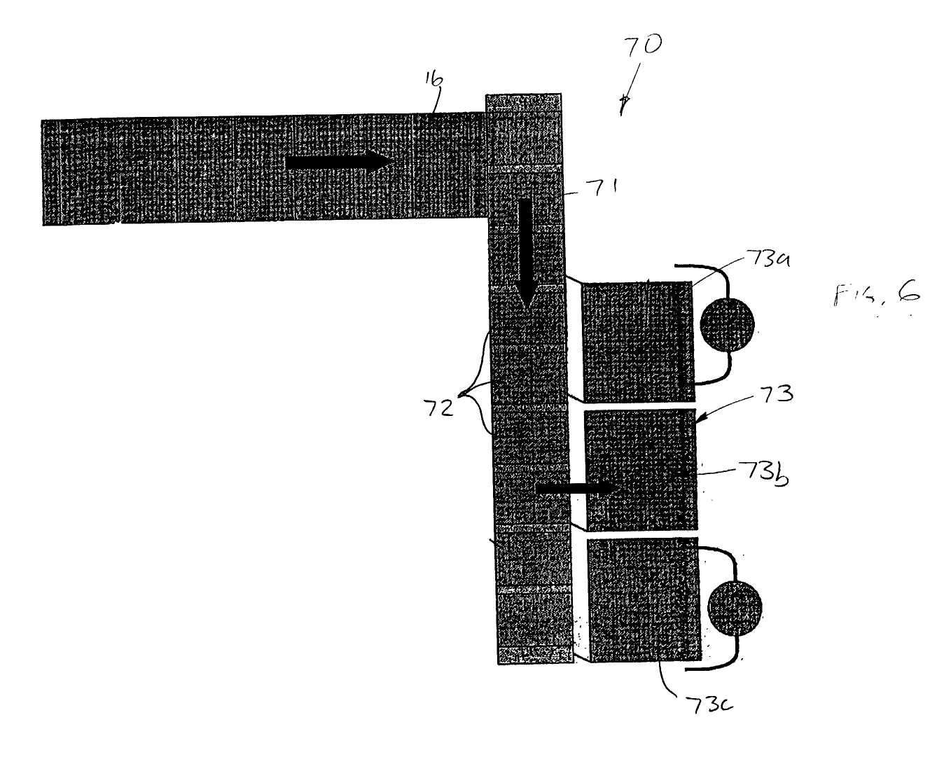

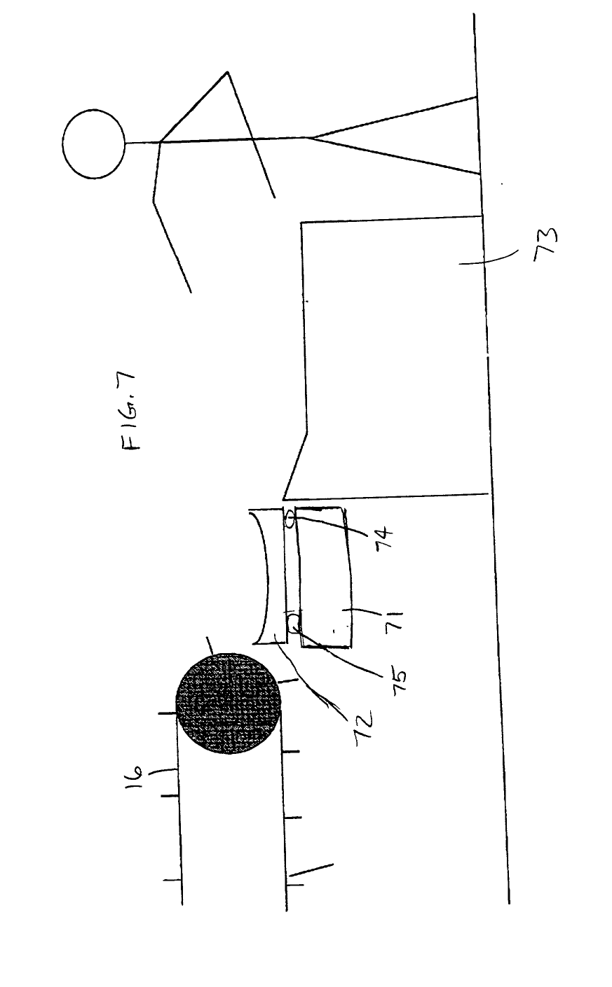

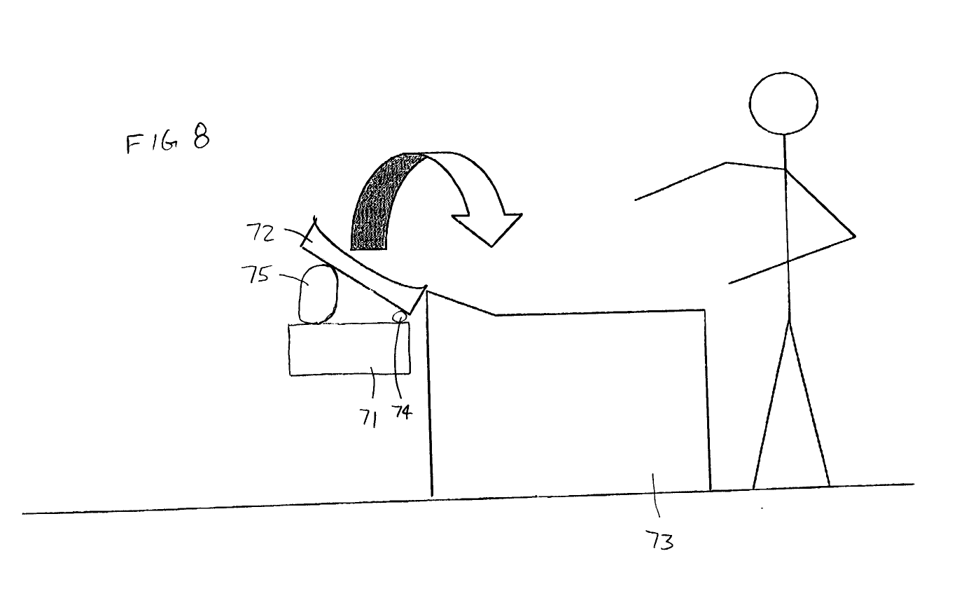

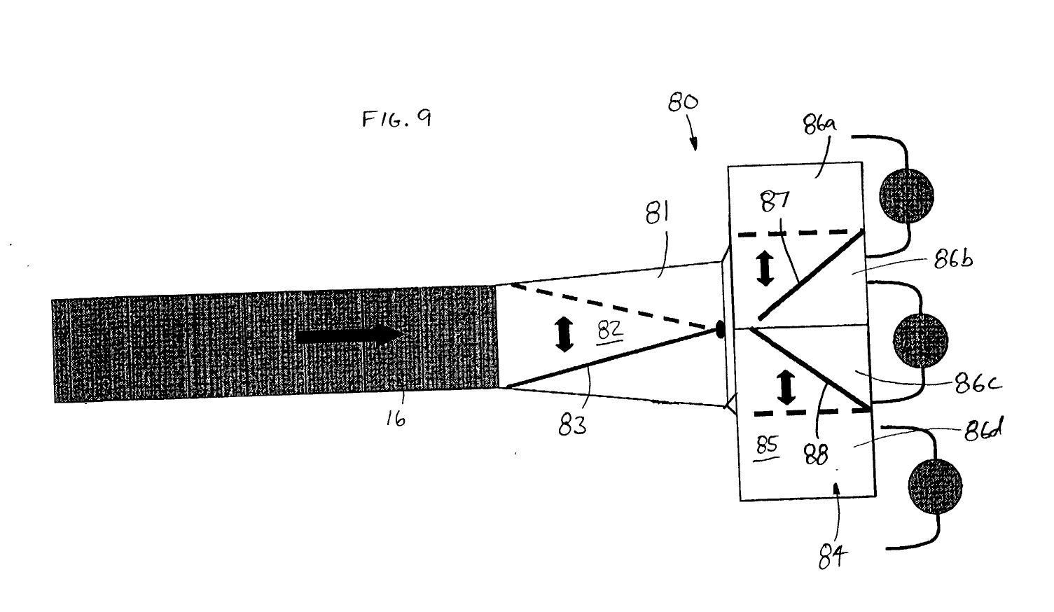

In accordance with certain aspects of the present invention, each of the containers 24 is associated with a specific section of the racks 12. As best shown in FIGS. 3 and 4, a section X of the racks 12 includes bin sections A, B, C, and D, each bin section including three bins, referred to herein as bins Aa, Ab, Ac, Ba, Bb, Bc, Ca, Cb, Cc, Da, Db, and Dc. One or more containers 24 may be assigned to each bin section. For example, bin section A has associated therewith containers A1, A2, A3, and A4. Likewise, bin sections B, C, and D all have 4 containers associated therewith. Each of the containers has a unique identifier such as a name or color so that a stock worker will quickly learn where specific containers are located. For example, container A1 may be named “alpha,” container A2 named “beta,” and so on. Furthermore, the names may be established by the stock workers to increase memory retention by the stock worker of the location of the individual containers.

An indicator system is provided to direct a stock worker to pick products from the desired bin. In the embodiment illustrated at FIG. 4, a central indicator 60 is provided for each rack section, including rack section X, and a bin indicator 61 is provided for each bin. The central indicator 60 includes a number display 44 for indicating the quantity of product to be pulled and a container name display 46 which identifies which container 24 into which the picked products are to be deposited. Each bin indicator 61 includes a light 42 which may be illuminated to attract the attention of the stock worker. During operation, when a selected product is to be picked, the central indicator 60 displays the quantity and container name, while the light 42 of the desired bin indicator 40 is illuminated. The worker may then quickly select the desired quantity of the product from the selected bin and deposit the product into the assigned container.

A computer 50 is operably connected to the pneumatic pistons 32, the central indicators 60, and the bin indicators 61 for directing the stock worker to fill an order (FIG. 1). The computer 50 is also connected to Input means (not shown) for entering information regarding orders to be filled. The computer 50 generates a sequence of picking instructions based on the orders so entered. Accordingly, the computer 50 is adapted to assign specific containers 24 for receiving parts of the various orders. The computer 50 further sequentially operates the indicators to direct the stock worker through a series of picking operations, each operation fulfilling an order. During a picking operation, the computer illuminates the light 42 of a bin indicator 61 associated with the desired product. The computer also activates the number display 44 and container display 46 of the appropriate central indicator 60 to indicate the quantity of product to be picked and to identify the assigned container 24 into which the product should be deposited. In response, the stock worker pulls the specified quantity of product and deposits the product into the assigned container 24. Once a picking operation is complete, the computer repeats the process for a subsequent picking operation by assigning a new container 24 and illuminating the same or different indicators 60, 61.

In a preferred embodiment, each bin indicator 61 further comprises a quitting switch 63 that is operable to generate a pick complete signal. As best shown in FIG. 4, the quitting switch 63 is provided next to the light display of each bin indicator 61. When a current order has been picked from a bin, the stock worker actuates the quitting switch 63 to deliver the pick complete signal. The computer may be programmed to interpret a pick complete signal from a subsequent picking operation as an indication that the product pulled during the immediately preceding picking operation has been placed in the assigned container 24. The pick complete signal will also indicate that the products have been pulled for the current picking operation and therefore the computer 50 will illuminate the indicators 60, 61 for the next picking operation. In the absence of a pick complete signal, the computer may initiate the next picking operation after a delay period such as, for example, 4 seconds.

In the preferred embodiment, each central indicator 60 further includes a direction display 62 for informing the stock worker of the position of the bin holding product for the next picking operation. As best shown in FIG. 4, the direction display 62 is operable to show an arrow 64 or other indicator directing the stock worker toward the bin 14 to be used in the next picking operation. By providing advance information regarding the next pick, the stock worker may efficiently deposit the products for the current pick in the assigned container and immediately begin stalking toward the general area of the bin 4 to be used in the next pick, thereby reducing the amount of time needed between subsequent picking operations. Each central indicator 60 further preferably includes a multi-purpose exception button 65 which may be used, for example, to repeat a previous picking instruction or to indicate that a particular item IS out of stock.

In an alternative embodiment, the central indicator 60 may be eliminated and an integrated bin indicator 70 may be provided for each bin. As best shown in FIG. 5, each integrated bin indicator 70 incorporates the number display 44, the container display 46, the light display 42, the direction display 62, the quitting switch 63, and the multi-purpose exception button 65 into a single indicator.

Once all of the parts of a specific order are deposited into various containers 24 after a series of picking operations, the computer actuates the pneumatic pistons 32 associated with those containers to discharge the products onto substantially the same section of conveyor 16. As the conveyor advances, each container 24 associated with a particular order discharges its contents onto the conveyor. As the section of conveyor 16 advances, downstream containers 24 associated with the same order are also actuated to deposit additional product onto the same section of conveyor 16. Ultimately, when all of the products for an order are discharged onto the same section of the conveyor 16, the order is advanced to the discharge end 20 of the conveyor where the products are deposited into the tote 22. The tote 22 is transported to a packing and shipping station for delivery.

In the currently preferred method, one stock worker is assigned to each section of the racks 12. As a result, each stock worker has a primary area of responsibility for fulfilling parts of orders requiring products in that stock worker's section. As the orders are entered into the computer, however, it may be recognized that many of the orders require products in a particular section or sections which may overburden the stock workers associated with those sections. Accordingly, the computer 50 may control the picking pattern so that workers from other sections are directed toward the heavy pick area of the bins 14.

While the containers 24 may be positioned so that the discharge of products onto the conveyor 16 is relatively gentle, it will be appreciated that discharge to the totes 22 may be forceful, and therefore such discharge is not suitable for delicate products. Accordingly, the end of the order-filling system 10 may be modified to include a delicate product packing station.

A first embodiment of a delicate product packing station 70 is illustrated at FIG. 6. In this embodiment, a transfer conveyor 71 has a receiving portion positioned adjacent the end of the central conveyor 16. The transfer conveyor 71 includes a plurality of trays 72. In the preferred embodiment, the each tray 72 is pivotably attached to the transfer conveyor 71, such as by a hinge 74. A packing table 73 is positioned adjacent a portion of the transfer conveyor 71. The trays 72 are independently actuatable, such as by mechanical means or an inflatable diaphragm 75, to rotate from a carrying position, in which the tray is substantially horizontal (FIG. 7), to a discharge position, in which an edge of each tray 72 is rotated away from the transfer conveyor 71 (FIG. 8), so that product carried by the tray 72 is gently transferred to the packing table 73. The packing table 73 may be divided into sections 73a, 73b, 73c, and the trays 72 may be operably connected to the computer, so that the trays discharge onto a desired table section. The delicate products may then be hand packed into a tote 22 for shipping.

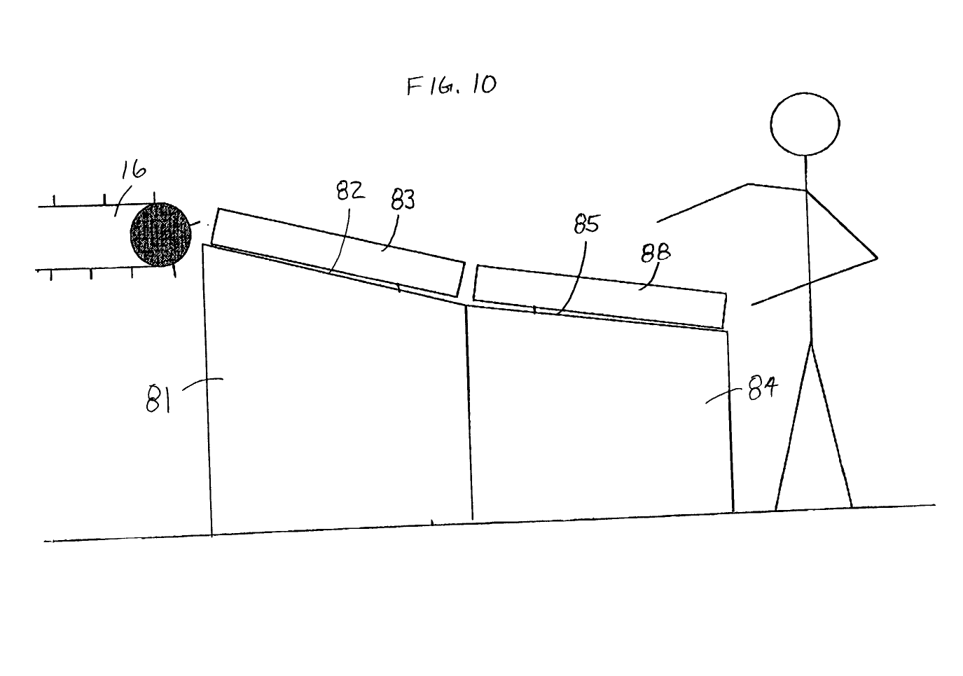

An alternative embodiment of the delicate product packing station is illustrated at FIGS. 9 and 10. In this embodiment, the delicate product packing station 80 includes a transfer chute 81 having a downwardly sloping surface 82 and a pivoting swing arm 83. A packing table 84, also having a downwardly sloping surface 85, is positioned adjacent the chute 81, and is divided into sections 86a-d. A pair of swing arms 87, 88 are positioned on the packing table 84. In operation, the chute swing arm 83 directs product to a desired side of the chute. The table swing arms 84, 85 also pivot to direct product from the chute 81 toward a specific table section 86a-d. A worker may be stationed at each table section to pack product directed to each section. In either embodiment, the delicate product packing station transfers products from the central conveyor 16 to a packing area in a gentle manner, to minimize breakage of delicate products.

The illustrated order-filling apparatus and methods advantageously increase order-filling efficiency by reducing the amount of time needed for each picking operation. Each stock worker is provided a visual indication which directs the stock worker toward the bin to be used during the picking operation. The destination for a particular pick is displayed at the bins which, when combined with the stock worker's knowledge of the container locations, allows the stock worker to immediately proceed toward the desired container. An advance indication of the location of the next pick is also given at the bins, thereby allowing the stock worker to immediately proceed toward the vicinity of the next pick after depositing the products for the first pick.

Although certain apparatus constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

What is claimed is:

1. A method of directing a stock worker to transfer stock items from various storage bins to containers according to a series of orders requesting desired quantities of specific stock items, wherein a light is associated with each bin, the method comprising:
assigning unique identifiers to each container;
illuminating a light associated with a bin holding a current item requested in a first order;
displaying a desired quantity of the current stock item;
assigning a container to the current stock item;
displaying the unique identifier for the assigned container; and
repeating the light illuminating, quantity displaying, container assigning, and identifier displaying steps for subsequent stock items requested in the first and subsequent orders.

2. The method of claim 1, further comprising a step of indicating a direction of a bin associated with a subsequent requested stock item.

3. The method of claim 1, further comprising a step of signaling completion of a stock item pick before repeating the method for a subsequent stock item.

4. The method of claim 1, in which a central indicator is provided for displaying the desired quantity and the unique identifier, and in which a bin indicator is provided for each bin, each bin indicators incorporating the light associated with the bin.

5. The method of claim 1, in which an integrated bin indicator is associated with each bin, each bin indicator incorporating the light associated with the bin, a number display for displaying the desired quantity, and a container display for displaying the unique identifier.

6. The method of claim 1, in which the containers are incorporated into order assembling apparatus.

7. Apparatus for directing a stock worker to transfer stock items from various storage bins to containers according to a series of orders requesting desired quantities of specific stock items, wherein each storage bin contains an associated stock item, the apparatus comprising:
a plurality of lights, each light associated with a bin;
at least one number display for showing a desired quantity of each stock item;
at least one container display for showing a unique container identifier associated with a selected container into which each stock item is to be placed, wherein each container is assigned a unique identifier; and
a computer operably connected to the lights, the at least one number display, and at least one container display, wherein the computer receives the orders for the stock items and assigns a selected container to each stock item, directs the at least one number display to show the desired quantity of each stock item, directs the at least one container display to show the unique container identifier associated with the selected container assigned to each stock item, and illuminates the light for the bin associated with the specific stock item, so that the stock worker is directed to transfer each stock item from the associated bin to the assigned container.

8. The apparatus of claim 7, further comprising a plurality of central indicators, in which each central indicator incorporates a number display and a container display, and wherein each central indicator is associated with a section of the bins.

9. The apparatus of claim 8, in which each central indicator further comprises an arrow display operably connected to the computer, the computer controlling each arrow display to illuminate an arrow directing the stock worker to a subsequent bin.

10. The apparatus of claim 8, in which each central indicator further comprises a multi-purpose exception button operably connected to the computer.

11. The apparatus of claim 8, in which the lights are incorporated into bin indicators associated with the bins, each bin indicator further comprising a quitting switch operably connected to the computer and adapted to generate a pick complete signal.

12. The apparatus of claim 7, further comprising integrated bin indicators associated with the bins, each integrated bin indicator including the number display, the container display, and the light.

13. The apparatus of claim 12, in which each integrated bin indicator further comprises an arrow display operably connected to the computer, the computer controlling each arrow display to illuminate an arrow directing the stock worker to a subsequent bin.

14. The apparatus of claim 12, in which each integrated bin indicator further comprises a quitting switch operably connected to the computer and adapted to generate a pick complete signal.

15. The apparatus of claim 12, in which each integrated bin indicator further comprises a multi-purpose exception button operably connected to the computer.

16. The apparatus of claim 7, in which several stock workers are assigned to primary bin sections, and in which the computer directs each stock worker to pick products from bins within the assigned primary bin section.

17. The apparatus of claim 16, in which the computer may override the assigned primary bin section to direct stock workers to heavy pick areas.

18. Apparatus for assembling orders requesting a series of desired quantities or specific stock items, the apparatus comprising:
a plurality of bins, wherein each bin holds a specific stock item;
a plurality of lights, each light having an associated bill;
a central conveyor positioned near the bins;
a plurality of containers positioned adjacent the central conveyor for temporarily holding stock items from the bins, each container having a unique identifier assigned thereto and including a dispenser operable to discharge stock items onto the central conveyor;
at least one number display for showing a desired quantity of each stock item;
at least one container display for showing the unique container identifier associated with a selected container into which each stock item is to be placed; and
a computer operably connected to the container dispensers, the at least one number display, the at least one container display, and the lights, wherein the computer receives the orders for the stock items and assigns a selected container to each stock item, directs the at least one number display to show the desired quantity of each stock item, directs the at least one container display to show the unique container identifier associated with the selected container assigned to each stock item, and illuminates the light for the bin associated with the specific stock item, so that the stock worker is directed to transfer each stock item from the associated bin to the assigned container, the computer further controlling the container dispensers holding a complete order to discharge at substantially the same point along the central conveyor.

19. The apparatus of claim 18, further comprising a plurality of central indicators, in which each central indicator incorporates a number display and a container display, and wherein each central indicator is associated with a section of the bins.

20. The apparatus of claim 19, in which each central indicator further comprises an arrow display operably connected to the computer, the computer controlling each arrow display to illuminate an arrow directing the stock worker to a subsequent bin.

21. The apparatus of claim t9, in which each central indicator Further comprises a multi-purpose exception button operably connected to the computer.

22. The apparatus of claim 19, in which the lights are incorporated into bin indicators associated with the bins, each bin indicator further comprising a quitting switch operably connected to the computer and adapted to generate a pick complete signal.

23. The apparatus of claim 18, further comprising integrated bin indicators associated with the bins, each integrated bin indicator including the number display, the container display, and the light.

24. The apparatus of claim 23, in which each integrated bin indicator further comprises an arrow display operably connected to the computer, the computer controlling each arrow display to illuminate an arrow directing the stock worker to a subsequent bin.

25. The apparatus of claim 23, in which each integrated bin indicator further comprises a quitting switch operably connected to the computer and adapted to generate a pick complete signal.

26. The apparatus of claim 23, in which each integrated bin indicator further comprises a multi-purpose exception button operably connected to the computer.

27. The apparatus of claim 18, in which several stock workers are assigned to primary bin sections, and in which the computer directs each stock worker to pick products from bins within the assigned primary bin section.

28. The apparatus of claim 27, in which the computer may override the assigned primary bin section to direct stock workers to heavy pick areas.

29. Delicate product handling apparatus for use with stock order filling apparatus having a central conveyor for receiving stock items, the central conveyor having an upper surface and a discharge end, the delicate product handling apparatus comprising:
a transfer conveyor having a loading portion positioned adjacent the discharge end of the central conveyor and a discharge portion;
a plurality of trays attached to the transfer conveyor, each tray having an upper surface with a receiving end substantially aligned with the central conveyor upper surface to receive stock items from the central conveyor and a discharge end, wherein each tray is adapted to move to a discharge position at the discharge portion of the transfer conveyor, thereby to discharge the stock items from the discharge end; and
a packing table positioned adjacent the discharge portion of the transfer conveyor, the packing table having a top surface with a rear edge substantially aligned with the discharge ends of the trays thereby to receive the stock items discharged from the trays.

30. The delicate product handling apparatus of claim 29, in which each tray is pivotably attached to the transfer conveyor, wherein each tray is rotated to the discharge position.

31. The delicate product handling apparatus of claim 30, in which each tray has an inflatable diaphragm associated therewith for rotating the tray to the discharge position.

32. The delicate product handling apparatus of claim 29, in which the packing table comprises a plurality of packing sections, and in which each tray is controlled to actuate to the discharge position at a selected packing section.

33. Delicate product handling apparatus for use with stock order filling apparatus having a central conveyor for receiving stock items, the central conveyor having an upper surface and a discharge end, the delicate product handling apparatus comprising:
a transfer chute having an upper surface with a first end positioned adjacent the central conveyor discharge end to receive stock items from the central conveyor and a second end, wherein the second end is lower than the first end so that the stock items slide from the first end to the second end under gravity force;
a chute swing arm pivotably mounted above the transfer chute and positioned to engage the stock items, the swing arm adapted to actuate between first and second positions thereby to direct the stock items to first and second sides, respectively, of the upper surface second end; and
a packing table having an upper surface positioned adjacent the second end of the chute upper surface adapted to receive the stock items from the transfer chute.

34. The delicate product handling apparatus of claim 33, in which the packing table comprises a plurality of packing sections.

35. The delicate product handling apparatus of claim 34, in which the packing table further comprises at least one swing arm pivotably mounted above the packing table upper surface and positioned to engage the stock items, thereby to direct the stock items to selected packing sections of the packing table.

36. The delicate product handling apparatus of claim 33, in which the packing table upper surface is sloped.
